(19) United States
(12) Patent Application Publication
(10) Pub. No.: US 2023/0065751 A1
(43) Pub. Date: Mar. 2, 2023

(54) PROMOTED OFFERS

(71) Applicant: eBay Inc., San Jose, CA (US)

(72) Inventors: Kishore Kumar Mohan, Fremont, CA (US); Ramesh Periyathambi, San Ramon, CA (US); Lakshimi Duraivenkatesh, San Ramon, CA (US); Mohan Patt, Hayward, CA (US)

(21) Appl. No.: 17/409,933

(22) Filed: Aug. 24, 2021

(51) Int. Cl. G06Q 30/02; G06N 20/00

(52) U.S. Cl. CPC G06Q 30/0224; G06N 20/00

(57) ABSTRACT

A method of training a machine learning model to promote an item is provided. Acceptance activity of a first entity is monitored and a determination of a first likelihood that the first entity accepts a future offer is made. The acceptance activity and the first likelihood are input as training data for the machine learning model for training purposes. An offer having an acceptance window and a characteristic is received from a second entity for a first item associated with the first entity. A second likelihood that the first entity will accept the offer is determined and an acceptance window is adjusted based on the determination. When the acceptance window closes, the method searches for a second item associated with a third entity based having the characteristic where an offer for the second item is sent to the second entity on behalf of the third entity.

### TECHNICAL FIELD

The subject matter disclosed herein generally relates to training a machine learning model. Specifically, in some examples the present disclosure addresses systems and methods for training machine learning models to predict the likelihood of a seller accepting an offer.

### BACKGROUND

Typically, when a buyer is interested in purchasing a certain item, such as a mobile device, the buyer spends a great amount of time conducting a search for the mobile device having certain characteristics. For example, the buyer searches for mobile devices within a particular price point, having certain features, having a certain color, etc. After spending a considerable amount of time searching for matching mobile devices, the buyer is presented with multiple purchase options. For example, a matching mobile device may be sold via an auction, where the buyer submits a bid and, after a given time period elapses, the entity with the highest bid receives the matching mobile device. A fixed price is another purchase option. Specifically, a search conducted by the buyer finds a matching mobile device that is being sold at a fixed price. Here, if the buyer is willing to purchase the matching mobile device at the fixed price, the buyer can buy the matching mobile device at the fixed price.

### BRIEF DESCRIPTION OF THE DRAWINGS

Some examples are illustrated by way of example and not limitation in the figures of the accompanying drawings.

FIG. 1 is a network diagram illustrating a network environment suitable for buying and selling items, according to some example embodiments.

FIG. 2 illustrates a user interface that allows a buyer to enter a search for an item where the user interface displays sale items that correspond to the item in response to conducting a search, according to some examples.

FIG. 3 illustrates a user interface that allows a user to enter an offer for a sale item displayed in the user interface of FIG. 2, according to some examples.

FIG. 4 illustrates a user interface that allows a user to accept offers from other sellers that are selling items similar to the sale item of FIG. 2, according to some examples.

FIG. 5 illustrates a system architecture that can be used to categorize a buyer, according to some examples.

FIG. 6 illustrates a method of determining a likelihood of a seller accepting an offer and training a machine learning model with this data, according to some examples.

FIG. 7 shows a method for adjusting an acceptance window associated with a first item having a characteristic and offering a second item having the characteristic when the acceptance window has closed, according to some examples.

FIG. 8 illustrates a notification sent to a second seller selling an item having characteristics in which a user may have an interest, according to some examples.

FIG. 9 illustrates a user interface that is provided upon activation of the notification of FIG. 8, according to some examples.

FIG. 10 shows a user interface provided to a second seller when an offer for an item offered for sale by the second seller is sent to a buyer, according to some examples.

FIG. 11 illustrates a method of providing a buyer with offers for other items having a characteristic that is similar to a sale item selected by the buyer, according to some examples.

FIG. 12 is a block diagram illustrating an example of a software architecture that may be installed on a machine, according to some examples.

FIG. 13 is a diagrammatic representation of a machine in the form of a computer system within which a set of instructions may be executed for causing the machine to perform any one or more of the methodologies discussed herein, according to an example.

### DETAILED DESCRIPTION

Reference will now be made in detail to specific examples for carrying out the subject matter. Examples of these specific embodiments are illustrated in the accompanying drawings. It will be understood that the drawings are not intended to limit the scope of the claims to the described embodiments. On the contrary, the drawings are intended to cover alternatives, modifications, and equivalents as may be included within the spirit and scope of the disclosure as defined by the appended claims. In the following description, specific details are set forth in order to provide a thorough understanding of the subject matter. Examples may be practiced without some or all of these specific details.

In some scenarios, when a buyer submits a search for an item, sellers who have the item that the buyer is searching for allow the buyer to submit an offer for the item with an offer option. Here, the seller accepts an offer that the seller is satisfied with and conducts the sale. Similar to the auction, the seller can accept the highest price submitted by buyer. However, typically, this offer option is not associated with a time period elapsing. Instead, when a buyer submits an offer using this option, one of three actions may occur. The offer is immediately accepted, the offer is immediately rejected, or the seller waits for other offers. In the situation where the seller waits for other offers, the buyer must wait for a response from the seller, which can take up to forty eight hours. Here, a strong possibility exists that the seller may not accept the offer submitted by the buyer and instead accepts a different offer. At this point, the buyer has to repeat the process and expend a great amount of time repeating their search.

Examples address this problem by providing the buyer with offers from other sellers for an item in which the buyer has expressed an interest. When a buyer submits an offer to a seller for a first item , the offer is associated with an acceptance window, which, in some examples is a time period, such as seventy-two fours, forty-eight hours, twenty-four hours, or the like. It should be noted that the acceptance window is not limited to any particular timeframe and thus may include any timeframe, such as a week or a month.

To further illustrate concepts disclosed herein, a buyer may be searching for a 2010 hard top Porsche™ 911 that has a manual transmission. A seller may be selling a blue 2010 Porsche™ 911 that is a hard top and has a manual transmission for $55,000. The buyer can submit an offer of $49,500 for the blue Porsche™ 911. In the illustration, the offer may be an associated with an acceptance window, which corresponds to a given period of time, and, in this illustration, is seventy-two hours.

If there is a likelihood that the seller will not accept the offer based on offers the seller accepted and rejected in the past, the acceptance window will be adjusted. In the illustration, if the seller is a car dealer and the seller typically does not accept offers for Porsche™ 911s that are not at least 95% of the asking price, which, in this case is $52,250, there is a likelihood the seller will not accept the offer for the blue 2010 Porsche™ 911. In the illustration, the buyer submitted an offer of $49,500, which is 90% of the asking price of $55,000. Thus, the seller will likely reject the offer. Here, the acceptance window will be adjusted from seventy-two hours to twenty-four hours.

Moreover, the buyer is categorized using the past buying behavior of the buyer. As will be discussed in greater detail below, the categorizations can include a new or reactivated buyer where the behavior relates to a buyer submitting an offer for the first time or the behavior can relate to a buyer allowing a significant amount of time to pass since the buyer last submitted an offer an on item. In the Porsche™ example above, a year may have passed since the buyer last made an offer an item, such as a mobile phone. In addition, as will be discussed further below, the behavior can include the buyer purchasing many items in the past using the submit an offer option. Moreover, the behavior can include the buyer using the submit an offer option in the past but the offers have been consistently declined, e.g., the buyer consistently makes offers that are too low to be considered by sellers. These behaviors could be used to categorize the buyer. Based on the categorization, when the buyer submits the offer for the first item, the buyer is presented with the option to accept offers from other sellers for second items that have the characteristic when the acceptance window closes.

In an embodiment, when a buyer submits an offer to a seller for an item in which the buyer has expressed an interest, a trained machine learning model is used to characterize the buyer. To further illustrate to concept of determining if a buyer has expressed an interest, in the Porsche™ 911 illustration above, the buyer has expressed an interest in the blue hard top 2010 Porsche™ 911 by submitting an offer for the blue hard top 2010 Porsche™ 911. Accordingly, a buyer can express an interest in an item when the buyer makes an offer on the item. Based on the characterization of the buyer, the buyer is offered the ability to accept offers from different sellers for items that are similar to the item for which the buyer submitted an offer. In the illustration, the buyer is offered the ability to accept offers for other 2010 Porsche™ 911s. Moreover, a determination is made regarding the likelihood of the seller accepting the offer, such as in the 2010 Porsche™ 911 illustration above, where the seller typically does not accept offers for Porsche™ 911s that are not at least 95% of the asking price, when an offer is made for an item sold by the seller that is 90% of the asking price, there is a likelihood that the seller will not accept the offer. In an example, offer acceptance activity of a seller for a first item is monitored and used to determine a likelihood of the seller accepting other offers for items having characteristics similar to the first item. In an example, using data corresponding to the offer activity of the seller, a machine learning model is trained such that the machine learning model can be used to determine the likelihood of the seller accepting other offers for the items having characteristics similar to the first item. In an example, the seller receives an offer associated with an acceptance window from a buyer for a second item having characteristics similar to the first item. Using the machine learning model, a determination is made regarding the likelihood of the seller accepting the offer for the second item. In an example, the acceptance window is adjusted based on the likelihood of the seller accepting the offer for the second item. In the 2010 Porsche™ 911 illustration above, since the offer was 90% of the asking price and the selling dealer typically does not accept anything below 95% of the asking price for Porsche™ 911s, the acceptance window can be adjusted from seventy-two hours to twenty-four hours based on the determination made by the trained machine learning model.

Moreover, once the window has closed, a search for a third item associated with a different seller and having characteristics similar to the item in which the buyer has expressed an interest is conducted. In an example, an offer for the third item associated with the different seller is sent to the buyer after the acceptance window has closed.

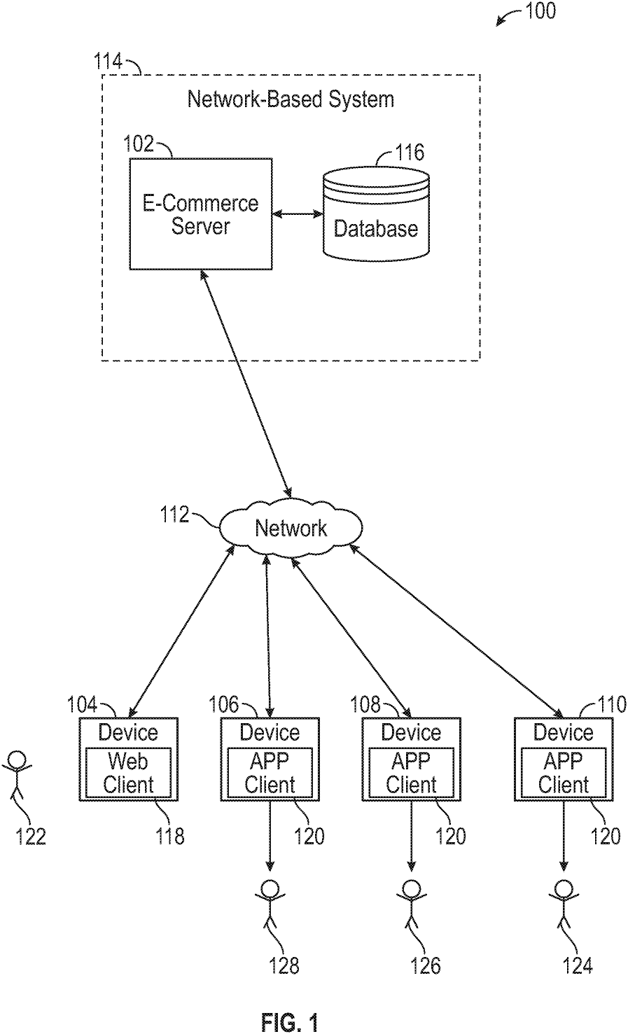

Now making reference to the Figures, and more specifically, FIG. 1, a network environment 100 that facilitates the buying and selling of items is shown, according to some examples. The network environment 100 includes an e-commerce server 102, along with devices 104-110 communicatively coupled to each other via a network 112. The e-commerce server 102 can further provide functionality that enables a buyer to purchase, submit an offer, and/or bid on an item listed for sale. For example, the e-commerce server 102 can provide user interface elements (e.g., button, text fields, etc.) that a buyer may use to select to purchase an item, place a bid, etc., as well as provide their financial (e.g., credit card number, bank account number) and personal information (e.g., shipping address, billing address, etc.) to complete the purchase. To view listings and/or purchase/bid on listed items, a buyer can create a user account with the online marketplace service 106.

To list an item for sale on the online marketplace, a seller can create a user account with the e-commerce server 102. The user account may include the personal information (e.g., name, address, email address, phone number, etc.) and financial information (e.g., credit card information, bank account information, etc.) associated with the seller. Once the seller has created a user account, the seller can then use their user account to utilize the functionality of the e-commerce server 102, including listing an item for sale.

The e-commerce server 102 can be part of a network-based system 114 that includes a cloud-based database 116. Examples of the database 116 can include the Simple Storage Service offered by Amazon Web Services™. Other examples of the database 116 can include a SwiftStack™ object storage system.

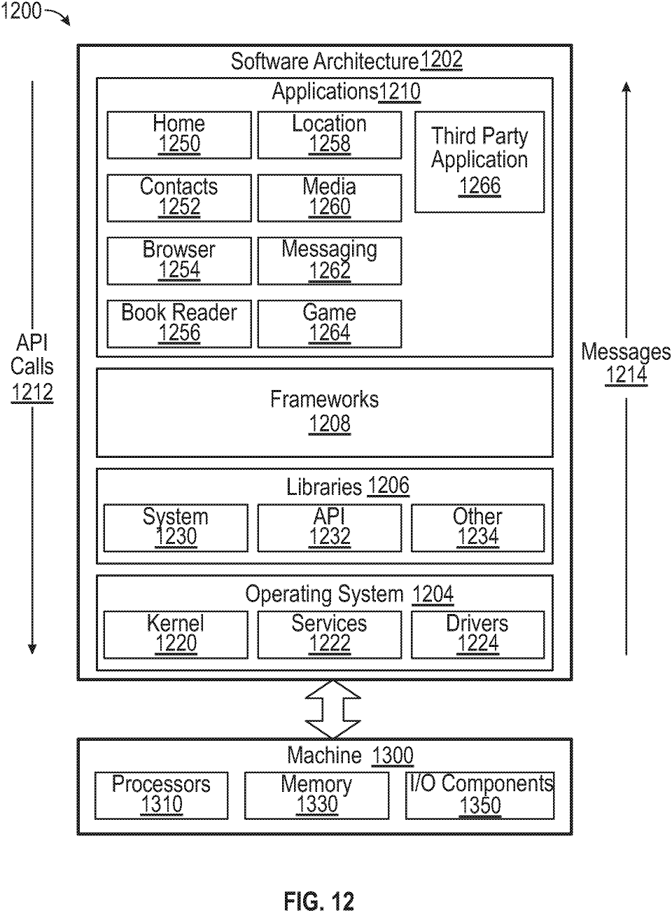

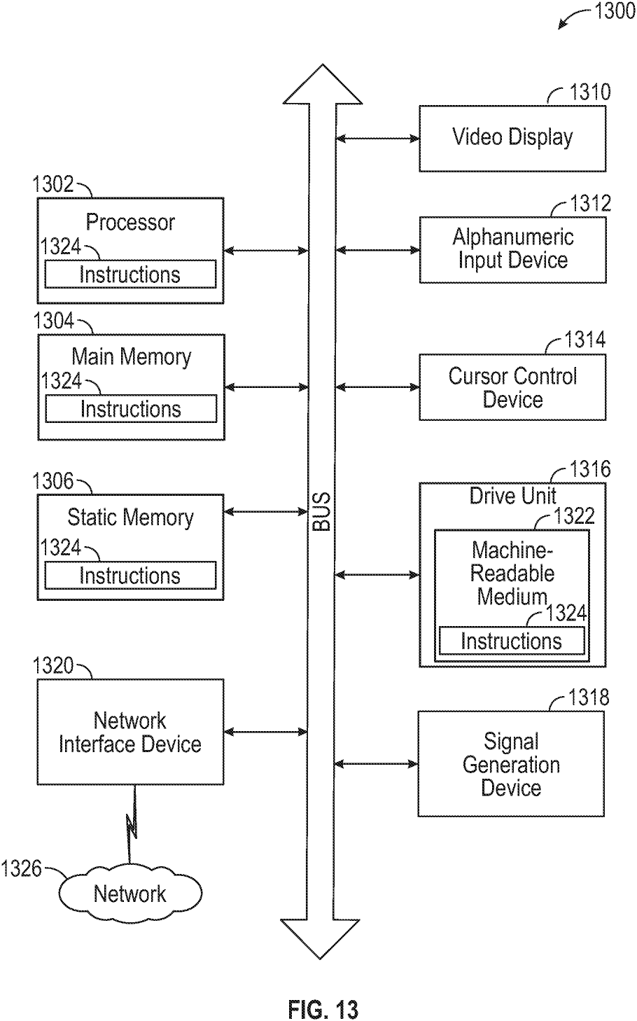

The devices 104-110 can interact with the e-commerce server 102 using a web client 118 or an app client 120. In an embodiment, the web client 118 can be a web browser, which allows for communication between a device, such as the device 104, and a web server. In particular, the web client can allow a user, such as a buyer 122, to make a request and then show a result of the request. The app client 120 can be a standalone application that runs on one of the devices 106-110 and communicates with a remote server to employ the services on the remote server, such as Bluetooth™ client application, or the like. Moreover, one of the devices 104-110 can be associated with the buyer 122. The e-commerce server 102 and the devices 104-110 can each be implemented in a computer system, in whole or in part, as described below with respect to FIGS. 12 and 13. The e-commerce server 102 provides an electronic commerce application to other machines (e.g., the devices 104-110) via the network 112. The electronic commerce application may provide a way for users to buy and sell items directly to each other, to buy from and sell to the electronic commerce application provider, or both.

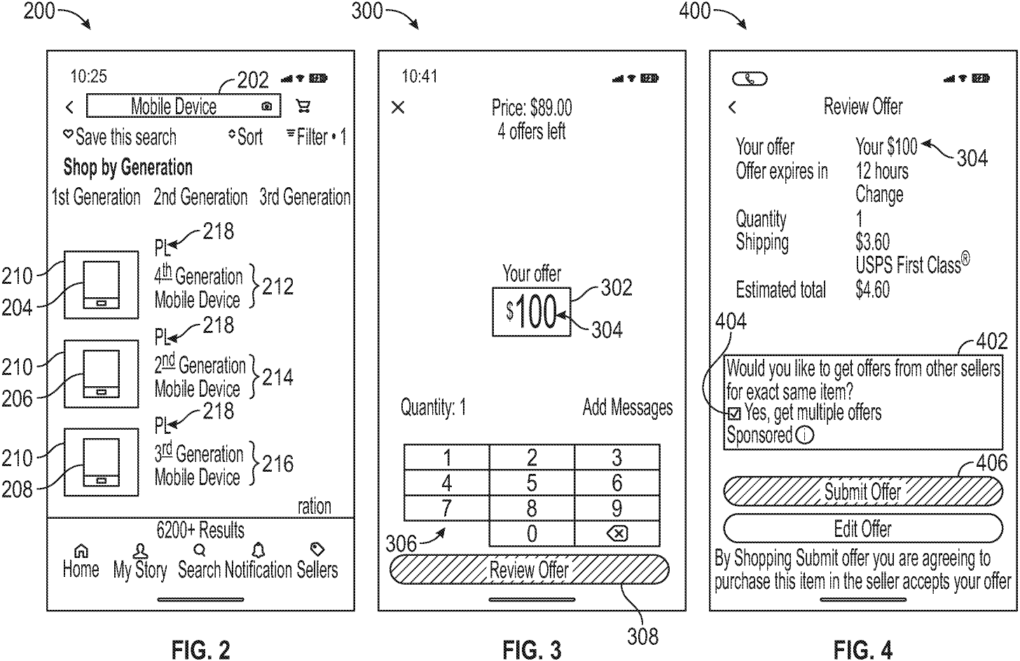

As noted above, embodiments relate to providing a buyer with offers from other sellers for an item in which the buyer has expressed an interest. Now making reference to FIG. 2, a user interface 200 is shown that receives input from a buyer for an item that the buyer wishes to purchase. In an embodiment, the buyer 122 desires to purchase a mobile device and enters a search string for a mobile device at an input field 202. In response, various sale items 204-208 appear in cards 210 of the user interface 200. It should be noted that throughout this Specification, reference may be made to either the sale items 204-208 or the sale item 204-208. Thus, the sale items 204-208 are interchangeable with the sale item 204-208 and the sale item 204-208 is interchangeable with the sale items 204-208.

Moreover, information that lists characteristics relating to each of the sale items are listed at fields 212-216, as shown with reference to FIG. 2. For example, the field 212 lists that the sale item 204 is a 4^{th} generation mobile device while the field 214 lists that the sale item 206 is a 2^{nd} generation mobile device. In addition, the field 216 lists that the sale item 208 is a 3^{rd} generation mobile device. In an example, each of the cards 210 displaying the sale items 204-208 is selectable. In an example, the features 4^{th} generation, 2^{nd} generation, 3^{rd} generation can be considered characteristics. Thus, when the buyer 122 desires one of the sale items 204-208, the buyer 122 can select the card 210 that corresponds to the desired sale item 204-208.

When the buyer 122 selects one of the sale items 204-208, a user interface 300 is displayed, which allows the buyer 122 to input an offer for the sale item 204-208, as shown with reference to FIG. 3. In particular, the user interface 300 includes an offer field 302 within which the buyer 122 can enter an offer 304 for one of the sale items 204-208 displayed in the user interface 200. More specifically, the buyer 122 can enter an amount corresponding to an offer using buttons 306. When the buyer 122 has entered an offer at the offer field 302, the buyer 122 can select a review offer button 308. Upon activation of the review offer button 308, a user interface 400 can be displayed to the buyer 122, as shown with reference to FIG. 4.

At the user interface 400, the buyer 122 can review the offer 304 entered at the offer field 302 of the user interface 300. Moreover, the user interface 400 includes a card 402 that provides the buyer 122 with the option of receiving offers from other sellers selling items having a characteristic that is similar to the sale item 204 selected by the user. Throughout this description, reference will be made to a characteristic of an item or characteristics of an item. It should be noted that either a single characteristic may be used selecting an item or more than one characteristic may be used for selecting an item. If the buyer 122 decides to receive offers from other sellers, the buyer 122 can select a box or field 404. To further illustrate, the sale item 204 includes a characteristic “4^{th} generation mobile device” listed in the field 212. When the buyer selects the field 404, other offers for a 4^{th} generation mobile device will be provided to the buyer. As will be discussed further below, other offers will be provided to the buyer 122 after an acceptance window related to the offer submitted via a button 406 closes.

In some embodiments, when the buyer 122 selects the review offer button 308 in the user interface 300, a determination can be made if the card 402 that displays the option to receive other offers from other sellers should be displayed in the user interface 400. Thus, the card 402 that includes the option to receive other offers from other sellers is variable where, for some buyers, the card 402 may not be displayed in the user interface 400 while for other buyers, the card 402 will be displayed in the user interface 400.

In embodiments, buyers, such as the buyer 122, interacting with the user interfaces 200-400 may be categorized based on their past buying behavior. In embodiments, based on a categorization of a buyer, the card 402 that includes the option to receive offers from other sellers for an item sharing a characteristic with the item that the buyer made an offer on will be provided to the buyer.

In an embodiment, one of the categories can correspond to a new or reactivated buyer (NORB). Thus, a NORB can be a buyer category. For example, in the illustration where the buyer 122 submitting the offer 304 at the offer field 302 is the first time the buyer has submitted any type of offer, the buyer 122 would be considered a NORB in accordance with an embodiment. Moreover, if a significant amount of time has elapsed since the buyer 122, in the case of an auction, made a bid or made an offer, the buyer will be classified as a NORB. In an embodiment, a significant amount of time can correspond to six months or greater, although any amount of time can be used. Moreover, a buyer will be considered a NORB if the buyer has perused a number of items for sale but has not purchased or attempted to purchase an item. Examples of attempting to purchase an item can include, in the case of an auction, making a bid or making an offer, where the bid did not win the auction or the offer was not accepted.

In an embodiment, a buyer can be categorized as a buyer who has purchased many items in the past by using an offer option. Thus, a buyer who regularly uses an offer option to purchase items can be a buyer category. For example, if a buyer regularly uses the offer field 302 to purchase items, such as on a monthly, weekly, or daily basis, the buyer can be classified as a buyer who has purchased many items in the past using an offer option.

In an embodiment, a buyer can be categorized as a buyer who has submitted offers, such as a bid in an online auction or an offer submitted using the offer field 302, and the offers have consistently been declined. Thus, a buyer who has their offers consistently declined can be a buyer category. To further illustrate, a buyer may consistently submit bids or offers that are low such that a seller typically will not accept the offer.

Moreover, in some embodiments, when a buyer submits an offer again, such as a bid in an online auction or an offer submitted using the offer field 302, typically, an acceptance window can be associated with the offer. In examples, the acceptance window can be a time window within which a seller can accept an offer from a buyer, where the offer relates to an item being sold by the seller. For example, when a buyer submits an offer via an online auction or via the offer field 302, a seller has a time window within which to respond to the offer, such as accepting the offer or rejecting the offer. This time window can be referred to as an acceptance window. If the acceptance window closes without a response from the seller, the offer is considered to be rejected by the seller. In some situations, the acceptance window may be of a duration that does not allow a seller enough time to accept the offer from the buyer. An acceptance window that may be considered as having a duration that does not allow a seller enough time to accept an offer may be, for example, from twelve hours to twenty-four hours.

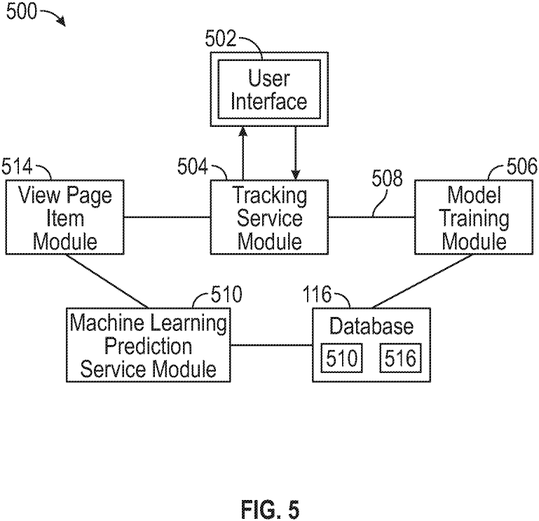

In an embodiment using machine learning techniques, the buyer can be classified as belonging to a particular category. For example, making reference to FIG. 5, an embodiment of a system architecture 500 that can be used to categorize a buyer as described above is shown. In particular, FIG. 5 illustrates a system architecture 500 that may be used with machine learning techniques in order to categorize a buyer. The system architecture 500 can include a user interface 502 provided on the devices 104-110 that allows a user to buy items. Moreover, the system architecture 500 can include a tracking service module 504, a model training module 506, a data pipeline 508, and the database 116 that stores a trained machine learning model 510. In addition, the system architecture 500 can include a machine learning prediction service module 512 and a view page item module 514.

The tracking service module 504 collects metrics associated with items that a buyer attempts to buy at the user interface 502. The metrics can include information about the attempt to buy, such as when the buyer attempted to make purchases, the amount of the purchase, and whether or not the buyer used an offer option (i.e., the buyer submitted an offer for an item using the best offer option available from ebay™). The metrics can also include information relating to whether or not sellers accepted offers from the buyer and the duration of acceptance windows associated with offers. The data collected by the tracking service module 504 can then be provided to the model training module 506 via the data pipeline 508, such as a Kafka pipeline.

The model training module 506 includes a large data platform that enables solving problems that involves large amounts of data requiring a great amount of computation, such as Apache Hadoop™. The model training module 506 uses machine learning to train the trained machine learning model 510. In an embodiment, the trained machine learning model 510 is generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique used by the model training module 506 is used to generate the trained machine learning model 510 based on metrics associated with items bought by a buyer and items a buyer attempted to buy. The trained machine learning model 510 is trained based on multiple attempts by a buyer to acquire items, which were both successful and unsuccessful. In machine learning parlance, such attempts are referred to as “features.” To generate and train a statistical model, a set of features is specified and a set of training data is identified.

Embodiments are not limited to any particular machine learning technique for generating or training the trained machine learning model 510. Example machine learning techniques include linear regression, logistic regression, neural networks, random forests, naive Bayes, Support Vector Machines (SVMs), XGBoost decision trees, or the like. Further examples of machine learning techniques that can be used include natural language processing such as Bidirectional Encoder Representations from Transformers (BERT). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

As discussed above, the buyer 122 may desire to make an offer on one of the sale items 204-208. When the buyer 122 makes an offer on one of the sale items 204-208 via the user interface 300, the machine learning prediction service module 512 accesses the trained machine learning model 510 from the database 116 and uses the trained machine learning model 510 to categorize the buyer 122.

The view item page module 514 provides and, in some instances, displays, the user interfaces 200, 300, and 400 based on an output from the machine learning prediction service module 512. For example, using the machine learning model 510, the machine learning prediction service module 512 determines that the buyer 122 can be categorized as a NORB, a buyer who regularly uses an offer option to purchase items, or a buyer who has offers consistently declined. In an embodiment, the system architecture 500 can provide a feedback loop where a categorization of a buyer can be changed based on the changing buying behavior of the buyer. For example, if the buyer was a NORB but then begins regularly using an offer option to purchase items, the categorization for the buyer can be changed from a NORB to a buyer who regularly uses an offer option to purchase items using the feedback loop and the trained machine learning model 510.

Returning attention to FIG. 4 and the user interface 400, when the buyer 122 selects the button 406, based on a categorization of the buyer 122, other offers will be provided to the buyer 122 after an acceptance window related to the offer closes. In an embodiment, the acceptance window can be adjusted based on the likelihood of the seller accepting the offer submitted by the buyer 122. In an embodiment, the likelihood of a seller accepting or rejecting an offer can first be determined and used as training data to train a machine learning model. Moreover, in an embodiment, using the trained machine learning model, when a buyer submits an offer associated with an acceptance window, the trained machine learning model can be used to determine the likelihood of the seller accepting the offer. In an embodiment, using this likelihood, the acceptance window associated with the offer can be adjusted.

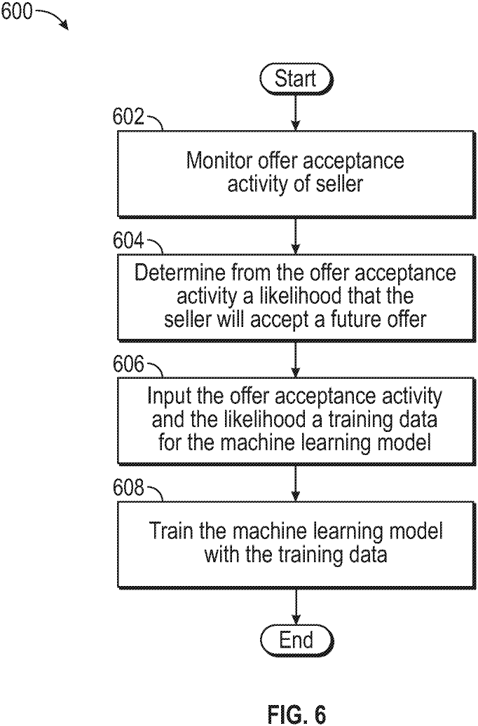

An example of determining a likelihood of a seller accepting an offer and training a machine learning model with this data is shown with reference to FIG. 6 and a method 600, in accordance with an embodiment. In an operation 602, acceptance activity of a seller is monitored. As an example, hereinafter using the “mobile device example,” a seller 124 associated with the device 110 may sell a high volume of mobile phones having 512GB of memory, a 6.5” display, facial recognition, and a core processor with a clock speed of at least 1.2 GHz, hereinafter referred to as “mobile device.” The tracking service module 504 collects data associated with offers made for the mobile devices being sold by the seller 124. During the operation 602, the tracking service module 504 collects data associated with offers accepted by the seller 124 and monitors the acceptance activity of the seller. To further illustrate, if the seller 124 has offered for sale three hundred mobile devices for $1000 and has accepted 75% of the offers made for the mobile devices, the tracking service module 504 collects this data.

In an operation 604, a likelihood that a seller will accept a future offer is determined. More specifically, during the operation 604, the tracking service module 504 provides the data associated with offers accepted by a seller to the model training module 506. In an embodiment, the model training module 506 can use this data to determine the likelihood of a seller accepting a future offer. In the example, the seller 124 has offered for sale three hundred mobile devices for $1000 and has accepted 75% of the offers made for the mobile devices. Moreover, each of the 75% offers that were accepted the seller were at least $900. Therefore, the model training module determines that if a buyer makes an offer of at least $900 for a mobile device that the seller is selling for $1000, there is a 75% chance the seller 124 will accept the offer and complete the sale. Moreover, in this example, the model training module 506 will determine that if an offer is less than $900, then there is a likelihood that the seller 124 will reject the offer.

After the model training module 506 determines a likelihood that a seller will accept a future offer in the operation 604, the method 600 performs an operation 606. In the operation 606, the offer acceptance activity and the likelihood that a seller will accept a future offer is provided as training data to a machine learning model. Using this training data, the machine learning model is trained to determine a likelihood that a seller will accept a future offer during an operation 608. In the mobile device example, during the operation 606, the model training module 506 provides data to the machine learning module 510 relating to when the seller 124 sells mobile devices for $1000 and receives an offer that is at least $900, there is a likelihood that the seller 124 will accept the offer. To further illustrate, every time a buyer has submitted an offer that is greater than ten percent lower than the price offered by the seller (i.e., $850 for a mobile device being offered for $1000), the seller rejects the offer. In this example, while ten percent is noted, any percentage, such as five percent, can be used as the threshold percentage beyond which the seller will reject the offer.

After inputting the data in the operation 606, the method 600 performs the operation 608, where the trained machine learning model 510 is trained to determine that when an offer greater than $900 is made to the seller 124 for the mobile device being sold by the seller for $1000, the seller 124 is likely to accept the offer. In addition, during the operation 608, the trained machine learning model 510 is trained to determine that when an offer less than $900 is made to the seller 124 for the mobile device being sold by the seller for $1000, the seller 124 will likely reject the offer.

As noted above, in embodiments, when a buyer submits an offer to a first seller for an item having a characteristic, such as a mobile phone having one of 512GB of memory, a 6.5” display, facial recognition characteristics, or a core processor with a clock speed of at least 1.2 GHz, the buyer can be offered other items having the same characteristic that are being sold by other sellers, i.e., a mobile phone having 512GB of memory, a 6.5” display, facial recognition characteristics, or a core processor with a clock speed of at least 1.2 GHz. In examples, the other offers are provided to the buyer after an acceptance window has closed.

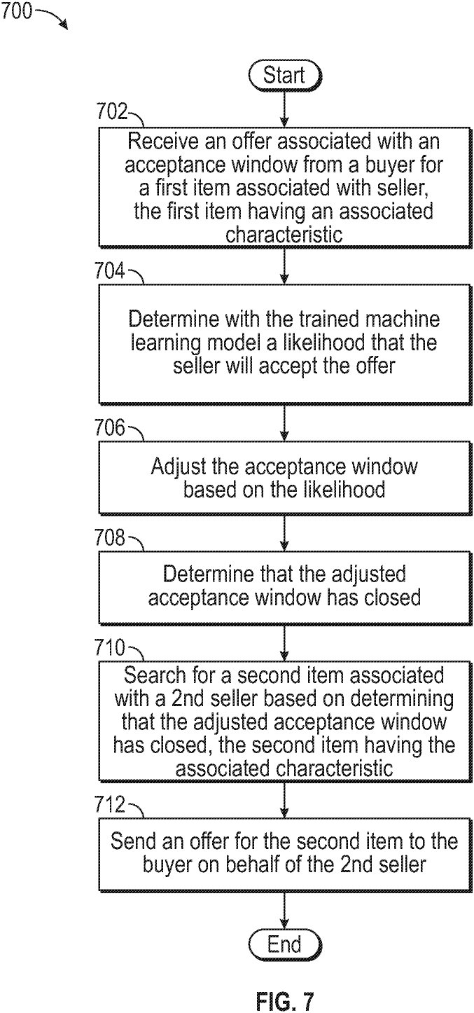

Making reference to FIG. 7, a method 700 is shown, which illustrates adjusting an acceptance window associated with a first item having a characteristic and offering a second item having the characteristic when the acceptance window has closed. It should be noted that while the method 700 is described as relating to items having the same characteristic, the method 700 can also apply to the scenario when a buyer submits an offer for an item having a first characteristic to a first seller, the buyer can be offered other items, having a second characteristic that is the same as the first characteristic or similar to the first characteristic, that are being sold by other sellers.

In an operation 702, an offer for a first item being sold by a first entity, such as a first seller, is received from a buyer. The offer can be associated with an acceptance window where the first item has an associated characteristic. As noted above, in embodiments, the acceptance window can be a time window within which a seller can accept an offer from a buyer, where the offer relates to an item being sold by the seller. Moreover, the characteristic can relate to a feature of the item, such as, in the case of a car, a hardtop, a manual transmission, a particular build year or, in the case of a mobile phone, 512GB of memory, a 6.5” display, facial recognition characteristics, or a core processor with a clock speed of at least 1.2 GHz. Once the offer is received in the operation 702, the method 700 performs an operation 704, where a trained machine learning model is used to determine the likelihood of the seller accepting the offer for the item. Based on the likelihood of the seller accepting the offer, the acceptance window can be adjusted in an operation 706 of the method 700. In embodiments, the acceptance window can be adjusted by any amount of time. To further illustrate, if an acceptance window is 72 hours, the acceptance window can be adjusted to 12 hours. Moreover, in an embodiment, the acceptance window can be adjusted based on the last one hundred offers or the last three months of offers data from that seller. Based on the prior offer data, if the offer amount of, for example, $200 for a particular item/product has been consistently rejected by the seller or if the seller response time is always late such that the offer expires, then the acceptance window will be adjusted to a shorter duration giving that time to another seller who will be more likely to accept the offer.

In the mobile device example, the seller 124 is selling mobile devices for $1000. During the operation 702, an offer from the buyer 122 for a first mobile device is received from the buyer 122. In other words, the buyer 122 has expressed an interest in the first mobile device. The first mobile device includes the characteristics of 512GB of memory, a 6.5” display, and a core processor with a clock speed of at least 1.2 GHz. Thus, the characteristics of 512GB of memory, a 6.5” display, and a core processor with a clock speed of at least 1.2 GHz can be considered associated characteristics of the first mobile device. In the mobile device example, the seller 124 listed the price for the first mobile device as $1000 and the buyer 122 offered the seller $890. Moreover, the offer made by the buyer 122 has an acceptance window of 72 hours. Thus, if the seller 124 does not accept the offer within 72 hours, the acceptance window closes and the offer is withdrawn.

During the operation 704, using the trained machine learning model 510, a determination is made that the seller will likely reject the offer. More specifically, in the method 600 above, the trained machine learning model 514 learned, in the mobile device example, that when the seller 124 receives an offer that is less than $900 for a mobile device being sold by the seller 124 for $1000, the seller 124 has rejected these offers. Therefore, in the operation 704, since the buyer 122 made an offer of $890 on an item which the buyer has expressed an interest, which is less than $900, a determination is made that the offer will likely be rejected by the seller 124. In the mobile device example, since the offer will likely be rejected, the acceptance window will be adjusted, for example, from 72 hours to 12 hours in the operation 706.

Once the acceptance window has been adjusted in the operation 706, the method 700 performs an operation 708 where a determination is made that the acceptance window has closed. In particular, if the acceptance window is adjusted from 72 hours to 12 hours, during the operation 708, a determination is made that that 12 hours have elapsed since the offer was received from the buyer. Accordingly, the acceptance window is closed. In response to determining that the acceptance window has closed in the operation 708, the method 700 performs an operation 710, where a search for a second item associated with a second seller is performed. In embodiments, the second item can have the associated characteristics of the first item. Thus, a search is conducted for items having characteristics of an item that a buyer has expressed an interest in.

Returning to the mobile device example, as noted above, in the operation 706, the acceptance window was adjusted from 72 hours to 12 hours. In the operation 708, a determination is made that 12 hours have elapsed from the time the offer was received from the buyer 122 in the operation 702. Thus, the operation 710 is performed where a search for a second mobile device being sold by a second seller having the associated characteristics of the first mobile device occurs. In the mobile device example, the first mobile device has the characteristics of 512GB of memory, a 6.5” display, and a core processor with a clock speed of at least 1.2 GHz. Therefore, during the operation 710, a search for a second mobile device having the associated characteristics of 512GB of memory, a 6.5” display, and a core processor with a clock speed of at least 1.2 GHz is performed.

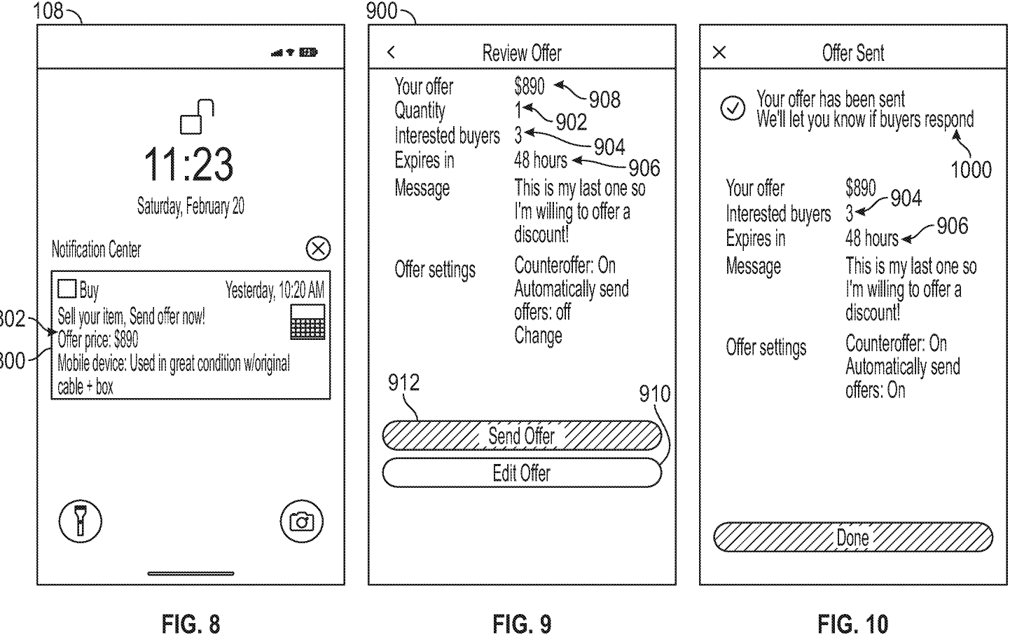

During the operation 710, when a second mobile device is found having the characteristics of the first mobile device in the mobile device example, a notification 800 is sent to the device 108 associated with a second seller 126 (FIG. 1), as shown with reference to FIG. 8. It should be noted that while only the notification 800 is shown as being sent to a single seller, such as the second seller 126, embodiments envision sending multiple notifications to multiple second sellers 126. In examples, the notification 800 includes the offer 802, which corresponds to the $890 offer made by the buyer 122 for the first mobile device. When the seller 126 activates the notification 800, a user interface 900 is provided on the device 108, which begins a seller initiated offer (SIO) as shown with reference to FIG. 9.

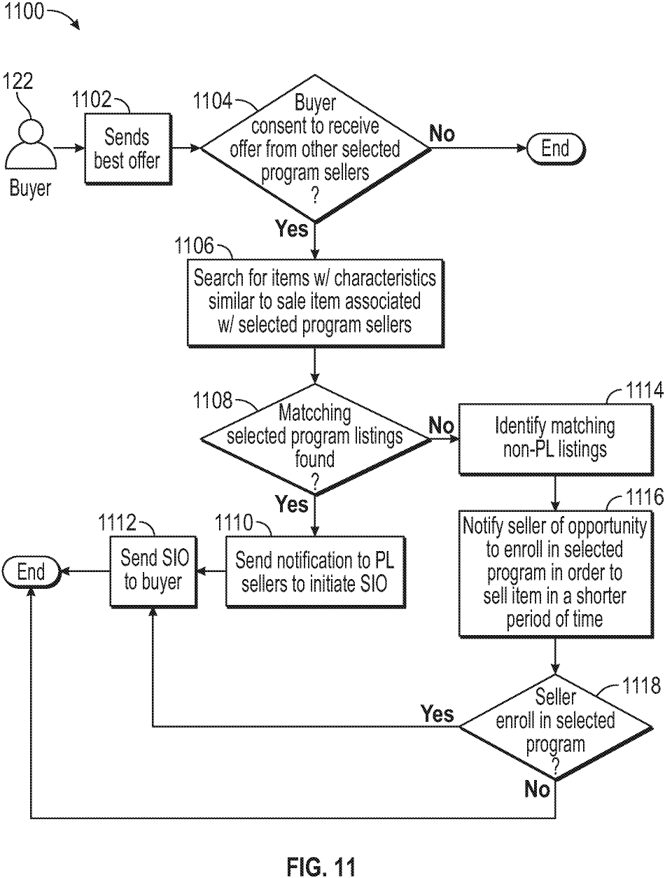

As may be seen with reference to FIG. 9, the user interface 900 lists a quantity 902 requested by the buyer 122 and a number of buyers 904 also interested in the second mobile device being sold by the second seller 126. Here, the buyer 122 is interested in one mobile device and there are three other buyers that are also interested in the second mobile device being offered by the second seller 126. The user interface 900 also includes an acceptance window 906, which lists the time duration of the offer that will be provided to the buyer 122. Here, the acceptance window is 48 hours. Nonetheless, any amount of time may be used for the acceptance window 906. Moreover, the user interface 900 provides an offer field 908 that shows the second seller 126 an amount being offered by the buyer 122, which in the mobile device example is $890. If the second seller 126 wishes to provide a counteroffer to the buyer 122 in a SIO, the second seller may activate an input 910 that allows the second seller to adjust the quantity 902 in the case where the buyer 122 is trying to buy more than one item, adjust the acceptance window 906, or insert a counteroffer at the offer field 908. If the second seller 126 is satisfied with the offer, the second seller may activate an input 912. Upon activation of the input 912, a user interface 1000 is displayed on the device 108, as shown with reference to FIG. 10.

Returning to FIG. 7 and the method 700, once the operation 710 has been completed, the method 700 performs an operation 712, where an offer, such as a SIO, for the second item is sent to the buyer on behalf of the second seller. Returning to the example and FIG. 10, in embodiments, the user interface 1000 displays that a SIO has been sent to the buyer 122 in the operation 712 of the mobile device example. Moreover, the user interface 1000 displays details of the offer to the second seller 126, such as the number of interested buyers 904 and the acceptance window 906.

As discussed above, embodiments provide an indication to a second seller that a buyer is interested in a first item from a first seller where the first item shares characteristics with a second item being sold by the second seller. The second seller can be selected based on a status associated with the second seller. To further illustrate, the second seller may be part of a selected program whose items are given priority over similar items sold by other sellers. An example of a selected program is the promoted listing (PL) program available from ebay™. In examples, making reference again to FIG. 2, when a buyer, such as the buyer 122, enters the search string for a mobile device at the input field 202 of the user interface 200, PL sellers 218 who have mobile devices for sale that match the search string are presented to the buyer 122.

As discussed above, when the buyer 122 selects the option of receiving offers for other items having a characteristic that is similar to the sale item 204 via the card 402, offers from second sellers, such as the second seller 126, are provided to the buyer 122. In examples, the second seller 126 can be a PL seller, such as the PL seller 218. In examples, the notification 800 can first be sent to the PL sellers 218 when the buyer 122 selects the option of receiving offers for other items having a characteristic that is similar to the sale item 204. Thus, items being sold by the PL sellers having characteristics that match a sale item selected by the buyer are searched, such as in the operation 710.

In addition to sending the notification to selected program sellers, such as the PL sellers 218, embodiments determine other second sellers 126 who are selling second items sharing characteristics with the first item that are not part of a selected program, such as the PL program. Moreover, embodiments may encourage the other second sellers 126 who are not part of a selected program to enter a selected program, such as the PL program, when the buyer 122 selects the option of receiving offers for other items having a characteristic that is similar to the sale item 204 via the card 402, as discussed with reference to FIG. 11.

Now making reference to FIG. 11, a method 1100 of providing a buyer with offers for other items having a characteristic that is similar to a sale item selected by the buyer is shown. In an operation 1102, the buyer 122 provides an offer for a sale item, as discussed above with reference to FIGS. 2-4. When the buyer 122 provides an offer for a sale item, the method 1100 performs an operation 1104 where a determination is made if the buyer 122 consents to receive an offer from other sellers that are part of a selected program. If the buyer 122 does not consent to receive an offer in the operation 1104, the method 1100 is complete.

As an example, during the operation 1102, making reference to FIG. 2, the buyer 122 makes an offer on the sale item 208 and selects the option of receiving offers for other items having a characteristic that is similar to the sale item 204 via the card 402 in FIG. 4. Returning to the mobile device example, the sale item 208 is a mobile device having 512GB of memory, a 6.5” display, facial recognition capabilities, and a core processor with a clock speed of at least 1.2 GHz. In the mobile device example, during the operation 1104, the method 1100 determines that the buyer 122 has consented to receive offers from selected program sellers. In this example, selected program sellers are sellers that are PL sellers, such as the PL sellers 218.

Returning attention to FIG. 11 and the method 1100, in response to determining that the buyer consented to receiving offers from other selected program sellers in the operation 1104, the method 1100 searches for items with characteristics that are similar to the sale item for which the buyer 122 made an offer in an operation 1106. Furthermore, during the operation 1106, items are searched that are being sold by selected program sellers. In an operation 1108, the method 1100 determines if any items having characteristics that are similar to the characteristics to the sale item selected by the buyer 122 are being sold by selected program sellers.

In the operation 1108, if a determination is made that that items are being sold by selected program sellers having characteristics that are similar to the characteristics of the sale item selected by the buyer 122, then an operation 1110 is performed, where a notification is sent to the selected program seller to begin a SIO, as discussed above with reference to FIGS. 8-10 and the notification 800. Moreover, the method 1100 performs an operation 1112 where a SIO is sent to the buyer 122 on behalf of the selected program seller, as discussed above with reference to FIG. 7 and the operation 712. Upon performance of the operation 1112, the method 1100 is complete.

Returning to the operation 1108, if a determination is made that no items are being sold by selected program sellers having characteristics that are similar to the characteristics of the sale item selected by the buyer 122, then an operation 1114 is performed. In the operation 1114, the method 1100 searches for items with characteristics that are similar to the sale item for which the buyer 122 made an offer. However, in contrast to the operation 1106, the items that are searched are items that are not being sold by selected program sellers. Instead, the items being searched are being sold by non-selected program sellers. When items are found having characteristics that are similar to the sale item for which the buyer 122 made an offer, the method 1100 performs an operation 1116.

During the operation 1116, the non-selected program sellers are notified of the opportunity to enroll in the selected program in order to potentially sell the item having characteristics that are similar to the sale item for which the buyer 122 made an offer in a shorter period of time. After notifying the non-selected program sellers of the opportunity to enroll in the selected program, a determination is made in an operation 1118 if the seller enrolled in the selected program.

Returning to the mobile device example, the sale item 208 is a mobile device having 512GB of memory, a 6.5” display, facial recognition capabilities, and a core processor with a clock speed of at least 1.2 GHz. Thus, the characteristics of the sale item 208 can be: 512GB of memory, a 6.5” display, facial recognition capabilities, and a core processor with a clock speed of at least 1.2 GHz. Therefore, in the operation 1106, other sale items having these characteristics (e.g., 512GB of memory, a 6.5” display, facial recognition capabilities, and a core processor with a clock speed of at least 1.2 GHz) are searched for in the operation 1106. In the example, mobile devices having 512GB of memory, a 6.5” display, facial recognition capabilities, and a core processor with a clock speed of at least 1.2 GHz being sold by the PL sellers 218 are searched for in the operation 1106. In this example, during the operation 1108, a determination is made that none of the PL sellers 218 are selling mobile devices having the characteristics of 512GB of memory, a 6.5” display, facial recognition capabilities, and a core processor with a clock speed of at least 1.2 GHz.

Therefore, in the mobile device example, the method 1100 performs the operation 1114 where mobile devices having the 512GB of memory, a 6.5” display, facial recognition capabilities, and a core processor with a clock speed of at least 1.2 GHz and are being sold by non-PL sellers are identified. During the operation 1114, a seller 128 (FIG. 1), who is not a PL seller 218, is identified as selling a mobile device having the characteristics of 512GB of memory, a 6.5” display, facial recognition capabilities, and a core processor with a clock speed of at least 1.2 GHz. Therefore, in the operation 1116, the seller 128 is notified of the opportunity to become a PL seller. In addition, the seller 128 is notified that the mobile device the seller 128 has for sale may be sold in a shorter period of time since, in this example, the buyer 122 is searching for a mobile device that the seller 128 is offering. In the example, the seller 128 decides to enroll in the selected program and become a PL seller. Thus, in the operation 1118, the method 1100 determines that the seller 128 has enrolled in the PL program and proceeds to perform the operation 1112, where a SIO for the mobile device being sold by the seller 128 is sent and the method 1100 is complete.

FIG. 12 is a block diagram 1200 illustrating a software architecture 1202, which may be installed on any one or more of the devices described above. FIG. 8 is merely a non-limiting example of a software architecture, and it will be appreciated that many other architectures may be implemented to facilitate the functionality described herein. The software architecture 1202 may be implemented by hardware such as a machine 1300 of FIG. 13 that includes a processors 1302, memory 1304 and 13006, and I/O components 1310 - 1314. In this example, the software architecture 1202 may be conceptualized as a stack of layers where each layer may provide a particular functionality. For example, the software architecture 1202 includes layers such as an operating system 1204, libraries 1206, frameworks 1208, and applications 1210. Operationally, the applications 1210 invoke application programming interface (API) calls 1212 through the software stack and receive messages 1214 in response to the API calls 1212, according to some implementations.

In various implementations, the operating system 1204 manages hardware resources and provides common services. The operating system 1204 includes, for example, a kernel 1220, services 1222, and drivers 1224. The kernel 1220 acts as an abstraction layer between the hardware and the other software layers in some implementations. For example, the kernel 1220 provides memory management, processor management (e.g., scheduling), component management, networking, and security settings, among other functionality. The services 1222 may provide other common services for the other software layers. The drivers 1224 may be responsible for controlling or interfacing with the underlying hardware. For instance, the drivers 1224 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1206 provide a low-level common infrastructure that may be utilized by the applications 1210. The libraries 1206 may include system libraries 1230 (e.g., C standard library) that may provide functions such as memory allocation functions, string manipulation functions, mathematic functions, and the like. In addition, the libraries 1206 may include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1206 may also include a wide variety of other libraries 1234 to provide many other APIs to the applications 1210.

The frameworks 1208 provide a high-level common infrastructure that may be utilized by the applications 1210, according to some implementations. For example, the frameworks 1208 provide various graphic user interface (GUI) functions, high-level resource management, high-level location services, and so forth. The frameworks 1208 may provide a broad spectrum of other APIs that may be utilized by the applications 1210, some of which may be specific to a particular operating system or platform.

In an example, the applications 1210 include a home application 1250, a contacts application 1252, a browser application 1254, a book reader application 1256, a location application 1258, a media application 1260, a messaging application 1262, a game application 1264, and a broad assortment of other applications such as a third-party application 1266. According to some embodiments, the applications 1210 are programs that execute functions defined in the programs. Various programming languages may be employed to create one or more of the applications 1210, structured in a variety of manners, such as object-orientated programming languages (e.g., Objective-C, Java, or C++) or procedural programming languages (e.g., C or assembly language). In a specific example, the third-party application 1266 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1266 may invoke the API calls 1212 provided by the mobile operating system (e.g., the operating system 1204) to facilitate functionality described herein.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other embodiments, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 13 is a block diagram of a machine within which instructions may be executed for causing the machine to perform any one or more of the methodologies discussed herein. In one example, the machine may be any of the devices described above. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device (cursor control device) 1314 (e.g., a mouse), a disk drive unit 1316, a signal generation device 1318 (e.g., a speaker) and a network interface device 1320.

The drive unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media. Instructions 1324 may also reside within the static memory 1306.

While the machine-readable medium 1322 is shown in an example to be a single medium, the term “machine-readable medium” may include a single medium or multiple media (e.g., a centralized or distributed database, and/or associated caches and servers) that store the one or more instructions or data instructions 1324. The term “machine-readable medium” shall also be taken to include any tangible medium that is capable of storing, encoding or carrying instructions 1324 for execution by the machine and that cause the machine to perform any one or more of the methodologies of the present invention, or that is capable of storing, encoding or carrying data structures utilized by or associated with such instructions 1324. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1324 for execution by the machine, and includes digital or analog communications signals or other intangible media to facilitate communication of such software.

Although an embodiment has been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A computer-implemented method of training a machine learning model to promote an item, the method comprising:
monitoring offer acceptance activity of a first entity;
determining from the offer acceptance activity a first likelihood that the first entity will accept a future offer;
inputting the offer acceptance activity and the first likelihood as training data for the machine learning model;
training the machine learning model with the training data;
receiving an offer associated with an acceptance window from a second entity for a first item associated with the first entity, the first item having an associated characteristic;
determining, using the machine learning model as trained using the training data, a second likelihood that the first entity will accept the offer;
adjusting, as an adjusted acceptance window, the acceptance window based on the second li kelihood;
determining that the adjusted acceptance window has closed;
searching for a second item associated with a third entity based on determining that the adjusted acceptance window has closed, the second item having the associated characteristic;
sending a notification to the third entity based on determining that the adjusted acceptance window has closed, the notification including:
the offer from the second entity; and
an option to activate the notification;
receiving an indication that the notification has been activated;
presenting to the third entity a user interface in response to receiving the indication that the notification has been activated, the user interface including an option to submit an offer by the third entity for the second item;
receiving a submission of the offer by the third entity for the second item at the user interface indicative of the third entity selecting the option to submit; and
sending the offer for the second item to the second entity on behalf of the third entity.

2. The computer-implemented method of claim 1, further comprising:
determining a status of the second entity; and
sending the offer for the second item associated with the third entity based on the status of the second entity.

3. The computer-implemented method of claim 1, wherein the third entity subscribes to have the offer for the second item sent to the second entity.

4. The computer-implemented method of claim 1, further comprising:
receiving a search request for items having the associated characteristic;
finding the items having the associated characteristic; and
sending a request to entities associated with the items to subscribe to having an offer for the items sent to the second entity.

5. The computer-implemented method of claim 4, further comprising sending an offer for the items to the second entity.

6. (canceled)

7. (canceled)

8. A non-transitory machine-readable medium having instructions embodied thereon, the instructions executable by a processor of a machine to perform operations comprising:
monitoring offer acceptance activity of a first entity;
determining from the offer acceptance activity a first likelihood that the first entity will accept a future offer;
inputting the offer acceptance activity and the first likelihood as training data for a machine learning model;
training the machine learning model with the training data;
receiving an offer associated with an acceptance window from a second entity for a first item associated with the first entity, the first item having an associated characteristic;
determining, using the machine learning model as trained using the training data, a second likelihood that the first entity will accept the offer;
adjusting, as an adjusted acceptance window, the acceptance window based on the second likelihood;
determining that the adjusted acceptance window has closed;
searching for a second item associated with a third entity based on determining that the adjusted acceptance window has closed, the second item having the associated characteristic; and
sending a notification to the third entity based on determining that the adjusted acceptance window has closed, the notification including:
the offer from the second entity; and
an option to activate the notification;
receiving an indication that the notification has been activated;
presenting to the third entity a user interface in response to receiving the indication that the notification has been activated, the user interface including an option to submit an offer by the third entity for the second item;
receiving a submission of the offer by the third entity for the second item at the user interface indicative of the third entity selecting the option to submit; and
sending the offer for the second item to the second entity on behalf of the third entity.

9. The non-transitory machine-readable medium of claim 8, the operations further comprising:
determining a status of the second entity; and
sending the offer for the second item associated with the third entity based on the status of the second entity.

10. The non-transitory machine-readable medium of claim 8, wherein the third entity subscribes to have the offer for the second item sent to the second entity.

11. The non-transitory machine-readable medium of claim 8, the operations further comprising:
searching for items having the associated characteristic;
finding the items having the associated characteristic; and
sending a request to entities associated with the items to subscribe to having an offer for the items sent to the second entity.

12. The non-transitory machine-readable medium of claim 11, the operations further comprising sending an offer for the items to the second entity.

13. (canceled)

14. (canceled)

15. A device, comprising:
a processor; and
memory including instructions that, when executed by the processor, cause the device to perform operations including:
monitoring offer acceptance activity of a first entity;
determining from the offer acceptance activity a first likelihood that the first entity will accept a future offer;
inputting the offer acceptance activity and the first likelihood as training data for a machine learning model;
training the machine learning model with the training data;
receiving an offer associated with an acceptance window from a second entity for a first item associated with the first entity, the first item having an associated characteristic;
determining, using the machine learning model as trained using the training data, a second likelihood that the first entity will accept the offer;
adjusting, as an adjusted acceptance window, the acceptance window based on the second likelihood;
determining that the adjusted acceptance window has closed;
searching for a second item associated with a third entity based on determining that the adjusted acceptance window has closed, the second item having the associated characteristic; and
sending a notification to the third entity based on determining that the adjusted acceptance window has closed, the notification including:
the offer from the second entity; and
an option to activate the notification;
receiving an indication that the notification has been activated;
presenting to the third entity a user interface in response to receiving the indication that the notification has been activated, the user interface including an option to submit an offer by the third entity for the second item;
receiving a submission of the offer by the third entity for the second item at the user interface indicative of the third entity selecting the option to submit; and
sending the offer for the second item to the second entity on behalf of the third entity.

16. The device of claim 15, wherein the instructions further cause the device to perform operations including:
determining a status of the second entity; and
sending the offer for the second item associated with the third entity based on the status of the second entity.

17. The device of claim 15, wherein the third entity subscribes to have the offer for the second item sent to the second entity.

18. The device of claim 15, wherein the instructions further cause the device to perform operations including:
searching for items having the associated characteristic;
finding the items having the associated characteristic;
sending a request to entities associated with the items to subscribe to having an offer for the items sent to the second entity; and
sending an offer for the items to the second entity.

19. (canceled)

20. (canceled)
